(19) United States
(12) Patent Application Publication
(10) Pub. No.: US 2011/0285830 A1
(43) Pub. Date: Nov. 24, 2011

(54) Stereoscopic Image Display Apparatus Capable Of Wirelessly Transmitting and Receiving Power

(75) Inventors: Eung Ju KIM, Gyunggi-do (KR); Shin Hwan Hwang, Gyunggi-do (KR); Jeong Hoon Kim, Seoul (KR)

(73) Assignee: SAMSUNG ELECTRO-MECHANICS CO., LTD., Gyeonggi-do (KR)

(21) Appl. No.: 12/881,875

(22) Filed: Sep. 14, 2010

(30) Foreign Application Priority Data
May 19, 2010 (KR) 10-2010-0047115

(51) Int. Cl. H04N 13/04

(52) U.S. Cl. 348/56; 348/E13.053

(57) ABSTRACT

Disclosed herein is a stereoscopic image display apparatus capable of wirelessly transmitting and receiving power. The stereoscopic image display apparatus includes a stereoscopic image display unit and shutter glasses. The stereoscopic image display unit divides stereoscopic images into images for the left eye and images for the right eye and displays the resulting stereoscopic images, generates a signal of opening/closing a right eye shutter and a left eye shutter, and generates a power signal and then wirelessly transmits power in a magnetic resonance coupling manner. The shutter glasses wirelessly receives the power signal from the stereoscopic image display unit in the magnetic resonance coupling manner, and provides the images for the left eye and the images for the right eye by alternatively opening and closing the left eye shutter and the right eye shutter in response to the signal of opening/closing the right eye shutter and the left eye shutter.

### CROSS REFERENCE TO RELATED APPLICATION

This application claims the benefit of Korean Patent Application No. 10-2010-0047115, filed on May 19, 2010, entitled “Stereoscopic Display Apparatus for Receiving and Transmitting Power by Wireless,” which is hereby incorporated by reference in its entirety into this application.

### BACKGROUND OF THE INVENTION

1. Technical Field

The present invention relates to a stereoscopic image display apparatus capable of wirelessly transmitting and receiving power.

2. Description of the Related Art

Recently, the development of 3-Dimensional (3D) displays has been accelerated at the request of users who want to feel the sense of reality from a screen.

Generally, methods of watching 3D Televisions (TVs) are divided into a method of watching a 3D TV with glasses and a method of watching a 3D TV without glasses. The method of watching a 3D TV with glasses has mainly been used in consideration of current technical levels and costs.

Methods of watching a 3D TV with glasses are divided into a passive method of using polarizing glasses and an active method of using shutter glasses which instantaneously close off right and left visual fields.

In general passive methods, an expensive 3D filter is installed on a TV screen or a theater's screen, thereby realizing a 3D screen. The passive method has advantages in that 3D images can be seen using glasses which do not include a special electric device and the price thereof is cheap, but has a disadvantage in that it doesn't have good picture quality in bright places when compared to the active method. Therefore, the passive method is suitable for using at a public place (for example, a theater) which is dark and in which a plurality of people gather and watch a screen.

Meanwhile, the active method is a method of allowing right and left eyes to alternatively watch a screen transmitted from a 3D TV by sequentially opening and closing the right and left shutters of dedicated glasses.

However, such an active method has disadvantages in that the price thereof is high because it requires an electric product which including an electric circuit and a battery used to open and close right and left shutters, and in that the sensation of wearing the glasses is not good because a battery is built in the glasses and the glasses are heavier than general glasses.

### SUMMARY OF THE INVENTION

Accordingly, the present invention has been made keeping in mind the above problems occurring in the prior art, and the present invention is intended to provide 3D glasses capable of wirelessly receiving power and a stereoscopic system including the same, which wirelessly provide power, so that the weight of the glasses is reduced, thereby improving the sensation of wearing the glasses.

In accordance with an aspect of the present invention, there is provided a stereoscopic image display apparatus capable of wirelessly transmitting and receiving power, including: a stereoscopic image display unit for dividing stereoscopic images composed in the frame unit or the field unit into images for the left eye and images for the right eye and displaying the resulting stereoscopic images, generating a signal of opening/closing a right eye shutter and a left eye shutter which are respectively synchronized with the images for the left eye and the images for the right eye, and generating a power signal and wirelessly transmitting power in a magnetic resonance coupling manner; and shutter glasses for wirelessly receiving the power signal from the stereoscopic image display unit in the magnetic resonance coupling manner, and providing the images for the left eye and the images for the right eye by alternatively opening and closing the left eye shutter and the right eye shutter in response to the signal of opening/closing the right eye shutter and the left eye shutter from the stereoscopic image display unit.

Further, the stereoscopic image display unit of the stereoscopic image display apparatus according to the present invention includes: a display for displaying the stereoscopic images; a stereoscopic image control unit for dividing the stereoscopic images composed in the frame unit or the field unit into the images for the left eye and the images for the right eye, generating the signal of opening/closing the right eye shutter and the left eye shutter which are respectively synchronized with the images for the left eye and the images for the right eye, and controlling the images for the left eye and the images for the right eye so that they are displayed on the display in response to a vertical synchronization signal and a horizontal synchronization signal; an opening/closing signal transmission unit for transmitting the signal of opening/closing the right eye shutter and the left eye shutter from the stereoscopic image control unit to the shutter glasses; and a power transmission unit for converting Alternating Current (AC) power input from the outside into Direct Current (DC) power, amplifying the DC power into power which is necessary to drive the shutter glasses, wirelessly transmitting the amplified power signal to the shutter glasses in the magnetic resonance coupling manner, determining whether the shutter glasses exist by detecting output power and reflected power, and cutting off the amplification of the DC power when the shutter glasses do not exist.

Further, the power transmission unit of the stereoscopic image display apparatus according to the present invention includes: an adaptor configured to convert the AC power input from the outside into the DC power; a frequency generation unit configured to convert the power from the adaptor into a predetermined frequency so as to wirelessly transmit the power received from the adaptor; a power amplifier configured to amplify the DC power into power which is necessary to drive the shutter glasses; a first resonant antenna configured to convert the power signal amplified by the power amplifier into magnetic energy and wirelessly transmit the magnetic energy to the shutter glasses in the magnetic resonance coupling manner; a variable transformer provided between the power amplifier and the first resonant antenna, and configured to match the impedance of the power amplifier and the first resonant antenna; a power pad switch provided between the frequency generation unit and the power amplifier, configured to connect the frequency generation unit to the power amplifier depending on the existence/non-existence of the shutter glasses, and configured to provide a bypass path so that the frequency generation unit is connected to the variable transformer; an output power detection unit configured to detect the output power of the variable transformer; a reflected power detection unit configured to detect reflected power reflected into the first resonant antenna; a coupler provided between the variable transformer and the first resonant antenna, configured to transmit the output power from the variable transformer to the first resonant antenna and the output power detection unit, and configured to transmit the reflected power reflected into the first resonant antenna to the reflected power detection unit; and a power transmission control unit configured to control the functions of the frequency generation unit, the power pad switch, the power amplifier, the variable transformer, and the first resonant antenna using the output power and the reflected power respectively detected by the output power detection unit and the reflected power detection unit.

Further, the opening/closing signal transmission unit of the stereoscopic image display apparatus according to the present invention wirelessly transmits the signal of opening/closing the right eye shutter and the left eye shutter to the shutter glasses using a Radio Frequency (RF) communication method or an infrared communication method.

Further, the opening/closing signal transmission unit of the stereoscopic image display apparatus according to the present invention transmits the signal of opening/closing the right eye shutter and the left eye shutter to the shutter glasses through a cable connected between the stereoscopic image display unit and the shutter glasses.

Further, the variable transformer of the stereoscopic image display apparatus according to the present invention includes: N first switches provided between a primary coil and the output terminal of the primary coil in order to adjust the turn ratio of the primary coil to a secondary coil; and M second switches provided between the secondary coil and the output terminal of the secondary coil.

Further, the N first switches and the M second switches of the stereoscopic image display apparatus according to the present invention are turned on or turned off in response to an impedance control signal from the power transmission control unit, so that the turn ratio of an input side to an output side is adjusted, thereby adjusting impedance between the power amplifier and the first resonant antenna.

Further, the shutter glasses of the stereoscopic image display apparatus according to the present invention include: a power reception unit configured to receive the power signal from the power transmission unit in the magnetic resonance coupling manner; and a shutter driving unit driven depending on the power from the power reception unit, configured to receive the signal of opening/closing the right eye shutter and the left eye shutter from the opening/closing signal transmission unit, and configured to alternatively open and close the left eye shutter and the right eye shutter in response to the signal of opening/closing the right eye shutter and the left eye shutter.

Further, the power reception unit of the stereoscopic image display apparatus according to the present invention includes: a second resonant antenna for receiving the magnetic energy from the first resonant antenna in the magnetic resonance coupling manner and converting the magnetic energy into the power signal; a rectification unit for rectifying the power signal received by the second resonant antenna; a DC/DC conversion unit for converting the power signal rectified by the rectification unit into DC voltage; and a power reception control unit for controlling the functions of the second resonant antenna, the rectification unit, and the DC/DC conversion unit.

Further, the first resonant antenna and the second resonant antenna of the stereoscopic image display apparatus according to the present invention respectively include: N capacitors connected in parallel; N inductors connected in serial; N third switches connected in serial to the respective N capacitors; and N fourth switches connected in parallel to the respective N inductors.

Further, the third switches and the fourth switches of the stereoscopic image display apparatus according to the present invention are turned on or turned off in response to impedance control signals from the power transmission control unit and the power reception control unit, so that the impedance of imaginary components of the first resonant antenna and the second resonant antenna is matched.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a stereoscopic image display apparatus capable of wirelessly transmitting and receiving power according to an embodiment of the present invention;

FIG. 2 is a block diagram showing the configuration of the power transmission unit of FIG. 1 in detail;

FIG. 3 is a block diagram showing the configuration of the power reception unit of FIG. 1 in detail.

FIG. 4 is a block diagram showing the impedance matching and the adjustment of the resonance frequencies of resonant antennas shown in FIGS. 2 and 3;

FIG. 5 is a block diagram showing the configuration of the variable transformer of FIG. 2 in detail; and

FIG. 6 is a flowchart showing a method of driving the stereoscopic image display apparatus capable of wirelessly transmitting and receiving power according to an embodiment of the present invention.

### DESCRIPTION OF THE PREFERRED EMBODIMENTS

Herein, words and terms used in the present specification and claims must not be interpreted as having common and dictionary meanings, but should be interpreted as having meanings and concepts in conformity with the technical spirit of the present invention based on the principle in which an inventor can appropriately define the concepts of terms in order to describe the inventor's own invention in the most appropriate way.

Reference now should be made to the drawings, in which the same reference numerals are used throughout the different drawings to designate the same or similar components.

Further, when it is determined that the detailed descriptions of well-known techniques related to the present invention would obscure the gist of the present invention, they will be omitted below.

Embodiments of the present invention will be described in detail below with reference to the attached drawings.

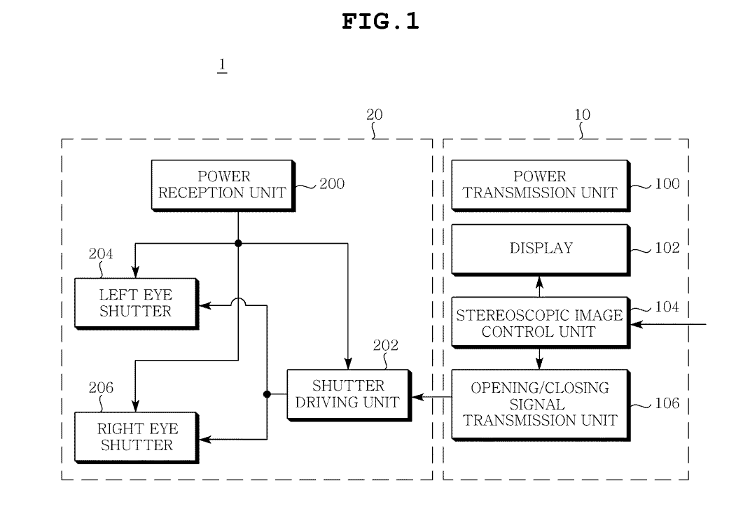

FIG. 1 is a block diagram showing a stereoscopic image display apparatus capable of wirelessly transmitting and receiving power according to an embodiment of the present invention.

The stereoscopic display apparatus 1 for wirelessly transmitting and receiving power according to an embodiment of the present invention includes a stereoscopic image display unit 10 and shutter glasses 20, as shown in FIG. 1.

The stereoscopic image display unit 10 divides stereoscopic images composed in the unit of a frame or a field into images for the left eye and images for the right eye and displays the resulting stereoscopic images, generates a signal of opening/closing a right eye shutter and a left eye shutter which are respectively synchronized with the images for the left eye and the images for the right eye, transmits the signal of opening/closing the right eye shutter and the left eye shutter to the shutter glasses 20 in a wireless or wired manner, and transmits power to the shutter glasses 20 in a magnetic resonance coupling manner.

For this purpose, the stereoscopic image display unit 10 includes a display 102, a stereoscopic image control unit 104, an opening/closing signal transmission unit 106, and a power transmission unit 100.

The display 102 alternately and repeatedly displays the images for the left eye and the images for the right eye divided by the stereoscopic image control unit 104 in response to a vertical synchronization signal and a horizontal synchronization signal input from the outside.

The stereoscopic image control unit 104 divides the stereoscopic images composed in the frame unit or in the field unit into the images for the left eye and the images for the right eye, generates the signal of opening/closing the right eye shutter and the left eye shutter which are respectively synchronized with the images for the left eye and the images for the right eye, and controls the images for the left eye and the images for the right eye so that they are displayed on the display 102 in response to a vertical synchronization signal and a horizontal synchronization signal.

The opening/closing signal transmission unit 106 transmits the signal of opening/closing the right eye shutter and the left eye shutter from the stereoscopic image control unit 104 to the shutter glasses 20 in the wired or wireless manner.

Here, the opening/closing signal transmission unit 106 wirelessly transmits the signal of opening/closing the right eye shutter and the left eye shutter to the shutter driving unit 202 of the shutter glasses 20 using a Radio Frequency (RF) communication method or an infrared communication method, or transmits the signal of opening/closing the right eye shutter and the left eye shutter to the shutter driving unit 202 of the shutter glasses 20 through a cable which connects the stereoscopic image display unit 10 to the shutter glasses 20.

The power transmission unit 100 converts Alternating Current (AC) power input from the outside into Direct Current (DC) power, amplifies the DC power into the power which is necessary to drive the shutter glasses 20, and wirelessly transmits the amplified power signal to the shutter glasses 20 in the magnetic resonance coupling manner.

Further, the power transmission unit 100 determines whether the shutter glasses 20 exist or not by detecting output power and reflected power. If the shutter glasses 20 do not exist, the power transmission unit 100 does not amplify the DC power.

The power transmission unit 100 will be described in detail later.

As shown in FIG. 1, the shutter glasses 20 include a power reception unit 200, a shutter driving unit 202, a left eye shutter 204, and a right eye shutter 206. The power reception unit 200 receives the power signal from the power transmission unit 100 of the stereoscopic image display unit 10 in the magnetic resonance coupling manner, and provides the power signal to the shutter driving unit 202, the left eye shutter 204, and the right eye shutter 206.

Therefore, the shutter driving unit 202, the left eye shutter 204, and the right eye shutter 206 are driven using power supplied from the power reception unit 200.

Meanwhile, when power is supplied from the power reception unit 200, the shutter driving unit 202 alternatively opens and closes the left eye shutter 204 and the right eye shutter 206 in response to the signal of opening/closing the right eye shutter and the left eye shutter received from the opening/closing signal transmission unit 106 of the stereoscopic image display unit 10.

Here, the left eye shutter 204 and right eye shutter 206 are respectively synchronized with the images for the left eye and the images for the right eye, so that a user who wears the shutter glasses 20 watches the images for the left eye when the left eye shutter 204 is opened, and the user watches the images for the right eye when the right eye shutter 206 is opened, with the result that the user who wears the shutter glasses 20 can watch the images displayed on the display 102 in the form of stereoscopic images.

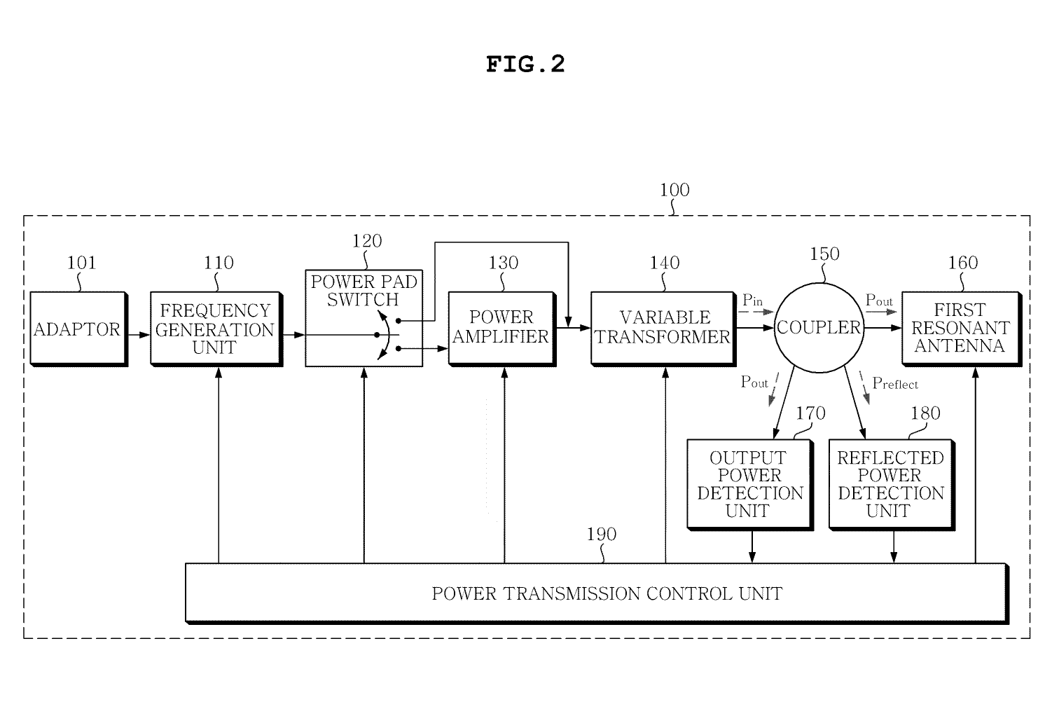

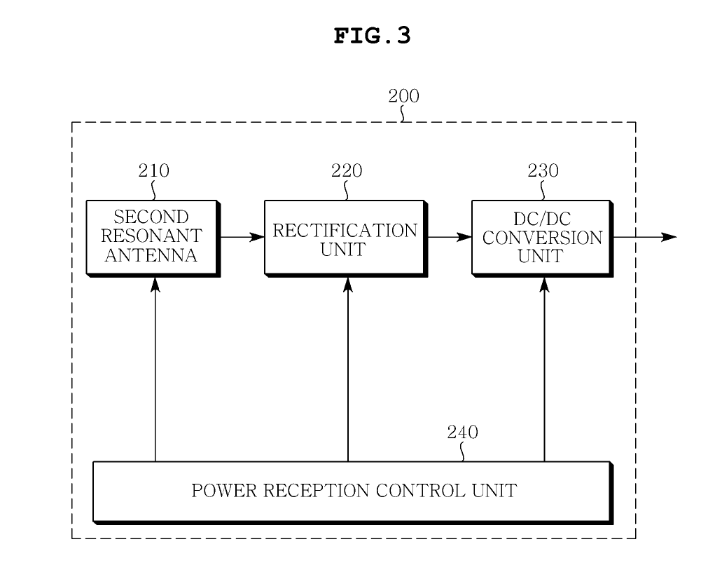

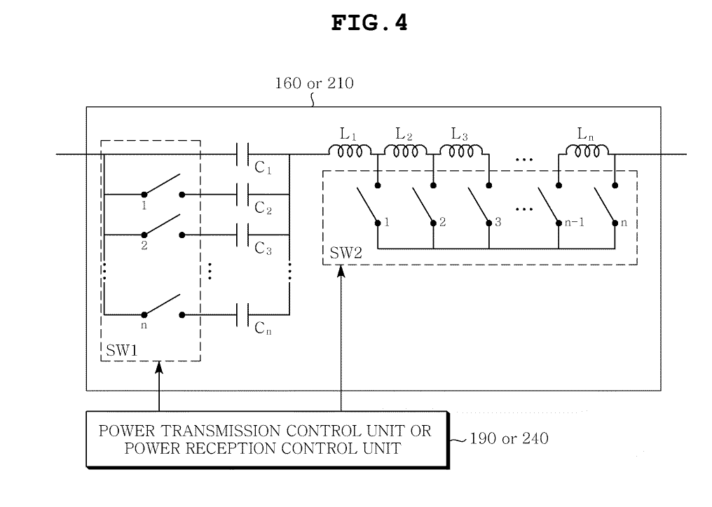

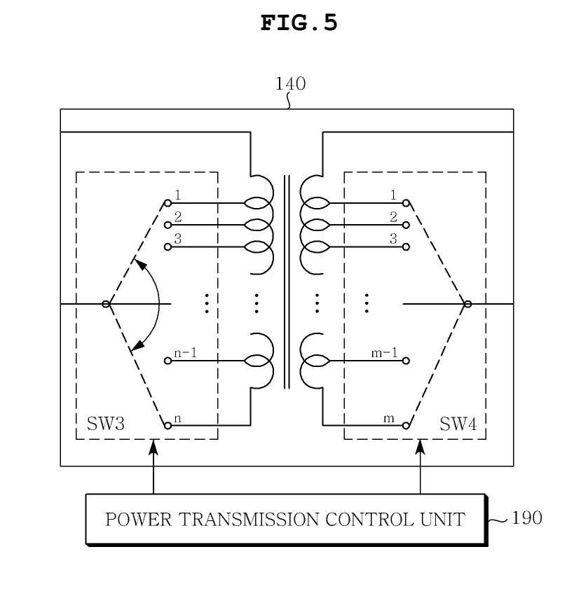

FIG. 2 is a block diagram showing the configuration of a power transmission unit of FIG. 1 in detail. FIG. 3 is a block diagram showing the configuration of a power reception unit of FIG. 1 in detail. FIG. 4 is a block diagram showing the impedance matching and the adjustment of the resonance frequencies of resonant antennas shown in FIGS. 2 and 3. FIG. 5 is a block diagram showing the configuration of a variable transformer of FIG. 2 in detail.

By referring to FIGS. 2 to 5, as shown in FIG. 2, the power transmission unit 100 includes an adaptor 101 configured to convert AC power input from the outside into DC power; a frequency generation unit 110 configured to convert the power received from the adaptor 101 into a predetermined frequency so as to wirelessly transmit the power; a power amplifier 130 configured to amplify the DC power into the power which is necessary to drive the shutter glasses 20; a first resonant antenna 160 configured to convert the power signal amplified by the power amplifier 130 into magnetic energy and configured to wirelessly transmit the magnetic energy to the shutter glasses 20 in the magnetic resonance coupling manner; a variable transformer 140 provided between the power amplifier 130 and the first resonant antenna 160 or between a coupler 150 and the first resonant antenna 160, and configured to match the impedance of the power amplifier 130 and the first resonant antenna 160; a power pad switch 120 provided between the frequency generation unit 110 and the power amplifier 130, configured to connect the frequency generation unit 110 to the power amplifier 130 depending on the existence/non-existence of the shutter glasses 20, and configured to provide a bypass path so that the frequency generation unit 110 is connected to the variable transformer 140; an output power detection unit 170 configured to detect the output power of the variable transformer 140; a reflected power detection unit 180 configured to detect reflected power reflected into the first resonant antenna 160; the coupler 150 provided between the variable transformer 140 and the first resonant antenna 160, configured to transmit the output power from the variable transformer 140 to the first resonant antenna 160 and the output power detection unit 170, and configured to transmit the reflected power reflected into the first resonant antenna 160 to the reflected power detection unit 180; and a power transmission control unit 190 configured to control the functions of the frequency generation unit 110, the power pad switch 120, the power amplifier 130, the variable transformer 140, and the first resonant antenna 160 using the output power and the reflected power respectively detected by the output power detection unit 170 and the reflected power detection unit 180.

In such a configuration of the power transmission unit 100, the adaptor 101, the frequency generation unit 110, the power pad switch 120, the variable transformer 140, the coupler 150, the output power detection unit 170, the reflected power detection unit 180, and the power transmission control unit 190 generate the power signal which is necessary to drive the shutter glasses 20, so that they can be called a power signal generation unit.

Meanwhile, the power reception unit 200 includes a second resonant antenna 210 for receiving the magnetic energy from the first resonant antenna 160, and converting the magnetic energy into a power signal in the magnetic resonance coupling manner; a rectification unit 220 for rectifying the power signal received by the second resonant antenna 210; a DC/DC conversion unit 230 for converting the power signal rectified by the rectification unit 220 into DC voltage; and a power reception control unit 240 for controlling the functions of the second resonant antenna 210, the rectification unit 220, and the DC/DC conversion unit 230.

The energy transmission between the power transmission unit 100 and the power reception unit 200, respectively having the above-described configurations, in the magnetic resonance coupling manner will be described in detail below.

A wireless power signal generated by the power transmission unit 100 is converted into magnetic energy due to LC resonance performed by the first resonant antenna 160 including an inductor L and a capacitor C, and the resulting magnetic energy is transmitted from the power transmission unit 100 to the power reception unit 200 through the second resonant antenna 210 including an inductor L and a capacitor C in the magnetic coupling manner.

Here, if the LC resonance frequency of the first resonant antenna 160 is adjusted to be the same as the LC resonance frequency of the second resonant antenna 210, the LC resonance frequencies are tuned, thereby maximizing the coupling of the magnetic energy.

That is, since transmission efficiency rapidly decreases depending on the degree of the inconsistency of the resonance frequencies of the first resonant antenna 160 and the second resonant antenna 210, it is preferable to match the resonance frequencies of the first resonant antenna 160 and the second resonant antenna 210 by calibrating the frequencies of the first resonant antenna 160 and the second resonant antenna 210.

For this purpose, for the impedance matching and the adjustment of the resonance frequencies of the first resonant antenna 160 and the second resonant antenna 210, a plurality of inductors L₁, L₂, . . . , Lₙ are connected in serial and a plurality of capacitors C₁, C₂, . . . , Cₙ are connected in parallel, as shown in FIG. 4.

Further, a plurality of first switches SW1 are respectively connected in serial to the plurality of capacitors C₁, C₂, . . . , Cₙ, and a plurality of second switches SW2 are respectively connected in parallel to the plurality of inductors L₁, L₂, . . . , Lₙ.

Further, the plurality of first switches SW1 and second switches SW2 are turned on or turned off in response to control signals from the power transmission control unit 190 and the power reception control unit 240 so that the resonance frequency of the first resonant antenna 160 is the same as the resonance frequency of the second resonant antenna 210.

That is, the power transmission control unit 190 and the power reception control unit 240 turn on or turn off the plurality of first switches SW1 and second switches SW2 so that the resonance frequency of the first resonant antenna 160 is the same as the resonance frequency of the second resonant antenna 210.

Therefore, the imaginary components of the impedance components of the first resonant antenna 160 and second resonant antenna 210 vary depending on the switching of the first switches SW1 and the second switches SW2, so that the impedance matching of the imaginary components of the first resonant antenna 160 and the second resonant antenna 210 is realized.

Meanwhile, although the first resonant antenna 160 and the second resonant antenna 210 have been described that they include the plurality of inductors L₁, L₂, . . . , Lₙ connected in serial and the plurality of capacitors C₁, C₂, . . . , Cₙ connected in parallel, the first resonant antenna 160 and the second resonant antenna 210 may include a single inductor and a plurality of capacitors C₁, C₂, . . . , Cₙ connected in parallel.

Here, the power transmission control unit 190 and the power reception control unit 240 turn on or turn off the first switches SW1 which are respectively connected in serial to the plurality of capacitors C₁, C₂, . . . , Cₙ, connected in parallel, so that the impedance matching of the imaginary components of the first resonant antenna 160 and the second resonant antenna 210 can be realized.

Meanwhile, the power transmission unit 100 uses the power amplifier 130 in order to increase or adjust the strength of the power. Although the power amplifier 130 requires load impedance of a several tens of Ω, it is necessary to compensate for impedance mismatching because load impedance mismatching occurs depending on magnetic coupling force between the first resonant antenna 160 and the second resonant antenna 210.

For this purpose, as shown in FIG. 5, a variable transformer 140 capable of adjusting real components of impedance components based on output power and reflected power is provided between the power amplifier 130 and the first resonant antenna 160 or between the coupler 150 and the first resonant antenna 160.

The variable transformer 140 includes a plurality of switches SW3 between a primary coil and the output terminal of the primary coil and a plurality of switches SW4 between a secondary coil and the output terminal of a secondary coil in order to adjust the turn ratio of the primary coil to the secondary coil. The switches SW3 provided between the primary coil and the output terminal of the primary coil and the switches SW4 provided between the secondary coil and the output terminal of the secondary coil are turned on or turned off in response to the impedance control signal from the power transmission control unit 190, so that the turn ratio of an input side to an output side is adjusted, with the result that impedance between the power amplifier 130 and the first resonant antenna 160 or the impedance between the coupler 150 and the first resonant antenna 160 is adjusted.

Meanwhile, the fourth rule of Maxwell's equations about electromagnetic wave defines that magnetic field always forms closed loops.

This can be interpreted as saying that, unlike the electric filed which spreads like water waves, the magnetic field has a nature of returning while describing circles, so that energy can be always preserved if there is no loss due to media.

Using such a nature, when the stereoscopic image display unit 10 is turned on (that is, when the power transmission unit 100 is turned on) and the shutter glasses 20 are turned off or do not exist, the output power and the reflected power respectively detected by the output power detection unit 170 and the reflected power detection unit 180 are almost the same, that is, there is almost no energy loss, so that the power transmission control unit 190 determines that the shutter glasses 20 do not exist, and controls the power pad switch 120 so that the power pad switch 120 forms a bypass path.

Therefore, if the shutter glasses 20 do not exist, the power used to drive the shutter glasses 20 is not transmitted from the power transmission unit 100, so that power loss, which may be generated when the shutter glasses 20 do not exist, can be reduced.

Meanwhile, when the shutter glasses 20 exist, the power transmission control unit 190 controls the switching of the power pad switch 120 so that the power pad switch 120 connects the frequency generation unit 110 to the power amplifier 130.

Further, the power transmission control unit 190 controls the power amplifier 130 based on the values of the output power and reflected power respectively detected by the output power detection unit 170 and the reflected power detection unit 180 so that the power which is necessary to drive the shutter glasses 20 is amplified by the power amplifier 130.

Further, the power transmission control unit 190 controls the switching of the switches provided in the variable transformer 140 and the switches provided in the first resonant antenna 160 so that the impedance between the power amplifier 130 and the first resonant antenna 160 is matched and the impedance between the first resonant antenna 160 and the second resonant antenna 210 is matched.

Therefore, the power signal generated by the power transmission unit 100 is converted into magnetic energy by the first resonant antenna 160, and the first resonant antenna 160 is magnetically coupled to the second resonant antenna 210, so that the magnetic energy obtained through the conversion by the first resonant antenna 160 is transmitted to the second resonant antenna 210.

Here, the LC resonance frequencies of the first resonant antenna 160 and the second resonant antenna 210 are adjusted to be the same by the power transmission control unit 190 and the power reception control unit 240, so that the first resonant antenna 160 and the second resonant antenna 210 are tuned, with the result that magnetic energy coupling is maximized and the magnetic energy obtained through the conversion by the first resonant antenna 160 is transmitted to the second resonant antenna 210 with maximum transmission efficiency.

Meanwhile, if the power transmission unit 100 is turned off, that is, if the input power to the stereoscopic image display unit 10 is cut off, the transmission of the power to the shutter glasses 20 is cut off, so that the power of the shutter glasses 20 is turned off.

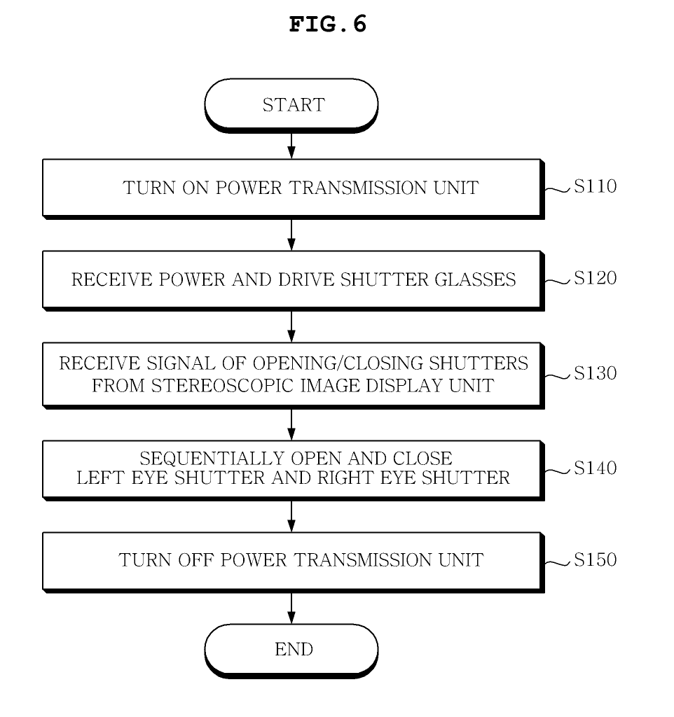

FIG. 6 is a flowchart showing a method of driving a stereoscopic image display apparatus capable of wirelessly transmitting and receiving power according to an embodiment of the present invention.

Referring to FIG. 6, first, if the power of the power transmission unit 100 is turned on, the power transmission unit 100 converts AC power input from the outside into DC power, amplifies the DC power into the power which is necessary to drive the shutter glasses 20, converts the amplified power signal into magnetic energy through the first resonant antenna 160, and then transmits the magnetic energy to the outside at step S110.

Here, the power transmission control unit 190 detects the output power of the amplified power signal and detects the reflected power of the power signal transmitted to the outside, thereby determining whether the shutter glasses 20 exist based on the difference of the values of the output power and the reflected power.

If the shutter glasses 20 exist, the power transmission control unit 190 controls the switching of the power pad switch 120 so that the power pad switch 120 connects the frequency generation unit 110 to the power amplifier 130. If the shutter glasses 20 do not exist, that is, the output power is almost the same as the reflected power, the power transmission control unit 190 controls the switching of the power pad switch 120 so that the power pad switch 120 forms a bypass path.

Meanwhile, when the power signal is transmitted from the power transmission unit 100, the shutter glasses 20 receive the power signal from the power transmission unit 100 through the second resonant antenna 210, and convert the power signal into voltage which is necessary to drive the shutter glasses 20 using the rectification unit 220 and the DC/DC conversion unit 230.

Thereafter, the power reception unit 200 of the shutter glasses 20 supplies the driving voltage received from the power transmission unit 100 to the shutter driving unit 202, the left eye shutter 204, and the right eye shutter 206, thereby driving the shutter driving unit 202, the left eye shutter 204, and the right eye shutter 206 at step S120.

Here, the shutter driving unit 202 is driven by the driving voltage from the power reception unit 200 and receives the signal of opening/closing the right eye shutter and the left eye shutter from the opening/closing signal transmission unit 106 at step S130.

Thereafter, the shutter driving unit 202 sequentially and alternatively opens and closes the left eye shutter 204 and the right eye shutter 206 in response to the signal of opening/closing the right eye shutter and the left eye shutter at step S140.

Therefore, a user who wears the shutter glasses 20 can see the stereoscopic images displayed on the display 102 due to the instantaneous opening/closing of the left eye shutter 204 and the right eye shutter 206.

Meanwhile, if the power transmission unit 100 is turned off, the shutter glasses 20 do not receive any power from the power transmission unit 100, so that the shutter glasses 20 is automatically turned off at step S150.

The stereoscopic image display apparatus capable of wirelessly transmitting and receiving power according to an embodiment of the present invention can reduce the weight of the shutter glasses generated due to a battery used so that the stereoscopic image display unit wirelessly transmits and receives power to and from the shutter glasses, thereby improving the sensation of wearing the shutter glasses. Further, in the stereoscopic image display apparatus capable of wirelessly transmitting and receiving power according to the embodiment of the present invention, the shutter glasses is turned on or turned off when the stereoscopic image display unit is turned on or turned off, so that the inconvenience of turning on or turning off the power of the shutter glasses can be eliminated.

According to the present invention, power is wirelessly provided to glasses, the weight of the glasses can be reduced, so that the sensation of wearing the glasses can be improved, and the supply of power to the glasses is stopped when the power of the stereoscopic image unit is turned off, so that the inconvenience of turning on or turning off the power of the glasses can be removed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A stereoscopic image display apparatus capable of wirelessly transmitting and receiving power, comprising:
a stereoscopic image display unit for dividing stereoscopic images composed in a frame unit or a field unit into images for a left eye and images for a right eye and displaying the resulting stereoscopic images, generating a signal of opening/closing a right eye shutter and a left eye shutter which are respectively synchronized with the images for the left eye and the images for the right eye, and generating a power signal and wirelessly transmitting power in a magnetic resonance coupling manner; and
shutter glasses for wirelessly receiving the power signal from the stereoscopic image display unit in the magnetic resonance coupling manner, and providing the images for the left eye and the images for the right eye by alternatively opening and closing the left eye shutter and the right eye shutter in response to the signal of opening/closing the right eye shutter and the left eye shutter from the stereoscopic image display unit.

2. The stereoscopic display apparatus as set forth in claim 1, wherein the stereoscopic image display unit comprises:
a display for displaying the stereoscopic images;
a stereoscopic image control unit for dividing the stereoscopic images composed in the frame unit or the field unit into the images for the left eye and the images for the right eye, generating the signal of opening/closing the right eye shutter and the left eye shutter which are respectively synchronized with the images for the left eye and the images for the right eye, and controlling the images for the left eye and the images for the right eye so that they are displayed on the display in response to a vertical synchronization signal and a horizontal synchronization signal;
an opening/closing signal transmission unit for transmitting the signal of opening/closing the right eye shutter and the left eye shutter from the stereoscopic image control unit to the shutter glasses; and
a power transmission unit for converting Alternating Current (AC) power input from an outside into Direct Current (DC) power, amplifying the DC power into power which is necessary to drive the shutter glasses, wirelessly transmitting the amplified power signal to the shutter glasses in the magnetic resonance coupling manner, determining whether the shutter glasses exist by detecting output power and reflected power, and cutting off the amplification of the DC power when the shutter glasses do not exist.

3. The stereoscopic display apparatus as set forth in claim 2, wherein the power transmission unit comprises:
an adaptor configured to convert the AC power input from the outside into the DC power;
a frequency generation unit configured to convert the power from the adaptor into a predetermined frequency so as to wirelessly transmit the power received from the adaptor;
a power amplifier configured to amplify the DC power into power which is necessary to drive the shutter glasses;
a first resonant antenna configured to convert the power signal amplified by the power amplifier into magnetic energy and wirelessly transmit the magnetic energy to the shutter glasses in the magnetic resonance coupling manner;
a variable transformer provided between the power amplifier and the first resonant antenna, and configured to match impedance of the power amplifier and the first resonant antenna;
a power pad switch provided between the frequency generation unit and the power amplifier, configured to connect the frequency generation unit to the power amplifier depending on existence/non-existence of the shutter glasses, and configured to provide a bypass path so that the frequency generation unit is connected to the variable transformer;
an output power detection unit configured to detect output power of the variable transformer;
a reflected power detection unit configured to detect reflected power reflected into the first resonant antenna;
a coupler provided between the variable transformer and the first resonant antenna, configured to transmit the output power from the variable transformer to the first resonant antenna and the output power detection unit, and configured to transmit the reflected power reflected into the first resonant antenna to the reflected power detection unit; and
a power transmission control unit configured to control the functions of the frequency generation unit, the power pad switch, the power amplifier, the variable transformer, and the first resonant antenna using the output power and the reflected power respectively detected by the output power detection unit and the reflected power detection unit.

4. The stereoscopic display apparatus as set forth in claim 2, wherein the opening/closing signal transmission unit wirelessly transmits the signal of opening/closing the right eye shutter and the left eye shutter to the shutter glasses using a Radio Frequency (RF) communication method or an infrared communication method.

5. The stereoscopic display apparatus as set forth in claim 2, wherein the opening/closing signal transmission unit transmits the signal of opening/closing the right eye shutter and the left eye shutter to the shutter glasses through a cable connected between the stereoscopic image display unit and the shutter glasses.

6. The stereoscopic display apparatus as set forth in claim 3, wherein the variable transformer comprises:
N first switches provided between a primary coil and an output terminal of the primary coil in order to adjust a turn ratio of the primary coil to a secondary coil; and
M second switches provided between the secondary coil and an output terminal of the secondary coil.

7. The stereoscopic display apparatus as set forth in claim 6, wherein the N first switches and the M second switches are turned on or turned off in response to an impedance control signal from the power transmission control unit, so that a turn ratio of an input side to an output side is adjusted, thereby adjusting impedance between the power amplifier and the first resonant antenna.

8. The stereoscopic display apparatus as set forth in claim 3, wherein the shutter glasses comprise:
a power reception unit configured to receive the power signal from the power transmission unit in the magnetic resonance coupling manner; and
a shutter driving unit driven depending on the power from the power reception unit, configured to receive the signal of opening/closing the right eye shutter and the left eye shutter from the opening/closing signal transmission unit, and configured to alternatively open and close the left eye shutter and the right eye shutter in response to the signal of opening/closing the right eye shutter and the left eye shutter.

9. The stereoscopic display apparatus as set forth in claim 8, wherein the power reception unit comprises:
a second resonant antenna for receiving the magnetic energy from the first resonant antenna in the magnetic resonance coupling manner and converting the magnetic energy into the power signal;
a rectification unit for rectifying the power signal received by the second resonant antenna;
a DC/DC conversion unit for converting the power signal rectified by the rectification unit into DC voltage; and
a power reception control unit for controlling functions of the second resonant antenna, the rectification unit, and the DC/DC conversion unit.

10. The stereoscopic display apparatus as set forth in claim 9, wherein the first resonant antenna and the second resonant antenna respectively comprise:
N capacitors connected in parallel;
N inductors connected in serial;
N third switches connected in serial to the respective N capacitors; and
N fourth switches connected in parallel to the respective N inductors.

11. The stereoscopic display apparatus as set forth in claim 10, wherein the third switches and the fourth switches are turned on or turned off in response to impedance control signals from the power transmission control unit and the power reception control unit, so that impedance of imaginary components of the first resonant antenna and the second resonant antenna is matched.
